(19) United States
(12) Patent Application Publication
(10) Pub. No.: US 2007/0179648 A1
(43) Pub. Date: Aug. 2, 2007

(54) Injury risk assessment data capture system and method

(76) Inventors: Kevin James Taylor, Christchurch (NZ); Robert van Nobelen, Christchurch (NZ)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/592,773

(22) Filed: Nov. 3, 2006

Related U.S. Application Data
(60) Provisional application No. 60/734,009, filed on Nov. 4, 2005.

(51) Int. Cl. G06F 17/00; G06F 19/00

(52) U.S. Cl. 700/90; 700/177

(57) ABSTRACT

The invention relates to a method of capturing user assessment data in addition to a data capture system, and computer-executable instructions configured to compile one or more sets of user assessment data. The user assessment data compiled is preferably used to assess a user's risk of injury caused by operating a computer. The methodology of the invention employs the process of firstly receiving computer usage data, then receiving user feedback data. In some instances the invention also receives computer configuration data. This received data is compiled into a user assessment data set.

### CROSS-REFERENCE TO RELATED APPLICATIONS

This application claims priority from U.S. Provisional Patent Application No. 60/734,009, filed on Nov. 4, 2005, which is incorporated herein by reference in its entirety.

### BACKGROUND OF THE INVENTION

1). Field of the Invention

This invention relates to a system and method to be used to capture data employed to assess injury risk. In particular the present invention may be employed to capture data used to assess the risk of injury present for users of computer input devices. The present invention may be used to identify and/or categorise particular users of such input devices depending on their level of injury risk.

2). Discussion of Related Art

The monitoring, prevention and treatment of work-related muscular-skeletal disorders is an important issue to many organisations and employers. For example, repetitive strain injury disorders affect the health, well-being and productivity of a work force which employs computer input devices, such as mice or keyboards in the day to day performance of their duties.

The current state of the art in this field provides software-based tools operating at the application level to facilitate injury prevention and rehabilitation. A good example of this type of existing tool is provided by the present applicant and is currently detailed at the internet domain www.workpace.com. This Workpace software product monitors a computer user's input behaviour and can provide reminders with respect to the timing of breaks they should take and exercises to be completed to reduce their risk of injury. Warnings can also be provided to users if they exceed recommended typing speeds or work too long without a break.

However, the current state of the art in this field does not necessarily allow for the proactive assessment and identification of computer users at significant risk of injury, nor can it subsequently recommend the most relevant risk factors appropriate for these users which should be addressed to reduce risk levels.

The first step involved with proactively addressing these issues is the recognition of computer users who are at risk of injury, or who may have a pre-existing condition aggravated by the use of computers. The assessment of injury risk in this field is difficult to complete accurately or quantifiably due to a significant number of variables at work which can contribute to such injuries.

Work station ergonomics, user fitness, posture and stress levels, typing speed and typing period durations, mouse speed and period durations, breaks or pauses taken by users and exercises completed by users all have an impact on risk of injury. Those working in this field will also appreciate that a large number of significant variables have an effect on a computer user's risk of injury, and the above list of factors should in no way be considered comprehensive.

Those skilled in the art will also appreciate that the types of data available for capture which is associated with such risk factors also varies widely. Data may be captured with respect to actual usage information relating to input events for a computer system and the actual use of the computer system. Other types of relevant data is only available through querying the user involved about their general health, fitness, stress levels, work environment or through observation of the user's posture, or through an assessment of the desk and seating arrangements available for a user when at work with their computer.

The current state of the art does not necessarily allow for such a wide variety and range of risk factor data to readily be captured. Some indicators associated with risk may be retrieved from actual computer usage or input activity-based information as may be gathered using the Workpace product. However, this raw data is not readily employed within a user risk assessment process, but simply provides an indicator as to the activity or behaviours of the user involved.

The determination or assessment of injury risk is also a comparatively new and evolving field. Rigorous scientific examination of contributing risk factors and underlying risk factors has yet to be completed to an exhaustive level for all relevant variables. Furthermore, such pre-existing studies and conclusions with respect to risk factors may be superseded by new technology which is employed in novel ways by users. In particular the use of laptop computers requires a reassessment of the importance or weighting of particular risk factors when the specific location at which laptops are used is to be considered. In addition, the compressed configuration of the laptop keyboard and trackball mouse add new variables to the mix of factors to be considered when injury risk is assessed.

Laptop users present special problems in the field of data capture associated with risk factors. Generally the working environment of the laptop user consists of wherever the user is when they have time available to use their laptop. Laptops may be balanced on laps, on coffee tables or hotel desks or on the meal trays of aircraft seats. This in turn results in a wide range or variety of working environments with variable ergonomic characteristics.

Furthermore, it is also possible (and recommended) for laptop users to interface additional external input devices such as standard size keyboards and standard mice with when they wish to work with their laptop for any extended period of time. Again, the ability to interface additional hardware or components with the laptop computer system presents a further challenge to data capture systems wishing to accurately track data associated with a laptop user's risk of injury.

It would therefore be of advantage to have an improved data capture system and/or method which could readily be employed to assess a user's risk of injury. In particular, a data capture system, method or apparatus that could capture variable working environment data, user psychological or physiological data, computer system usage data or computer system hardware configuration data would be of advantage.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand, the United States or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### SUMMARY OF THE INVENTION

According to one aspect of the present invention, there is provided a method of data capture adapted to compile at least one set of user assessment data, said user assessment data being used to assess a user's risk of injury caused by operating by a computer, said method being characterised by the steps of;
(i) receiving computer usage data, and
(ii) receiving user feedback data, and
(iii) compiling said received user feedback data and computer usage data into a user assessment data set.

According to yet another aspect of the present invention, there is provided a method of data capture adapted to compile at least one set of user assessment data, said user assessment data being used to assess a user's risk of injury caused by operating by a computer, said method being characterised by the steps of;
(i) receiving computer usage data, and
(ii) receiving user feedback data, and
(iii) receiving computer configuration data, and
(iv) compiling said received user feedback data, computer usage data and computer configuration data into a user assessment data set.

According to yet another aspect of the present invention, there is provided a data capture system adapted to compile at least one set of user assessment data, said user assessment data being used to assess a user's risk of injury caused by operating a computer, said system including

an input means adapted to receive computer usage data and user feedback data, and

a local data storage means adapted to compile and store computer usage data and user feedback data into a user assessment data set, and

an output means adapted to transmit at least a portion of a stored user assessment data set.

According to yet another aspect of the present invention, there is provided a data capture system substantially as described above wherein the input means is also adapted to receive computer configuration data, and the local data storage means is adapted to compile said received computer configuration data into a user assessment data set.

According to yet another aspect of the present invention, there is provided an injury risk assessment system substantially as described above wherein the output means is in communication with a dynamic data store, said dynamic data store being configured to store a plurality of sets of user assessment data sourced from a plurality of users, said dynamic data store being configured to update said stored user assessment data sets when a current user assessment data set is received for a user.

According to yet another aspect of the present invention, there are provided computer-executable instructions stored on a computer-readable medium, said instructions being adapted to facilitate the compilation of at least one set of user assessment data.

According to one further aspect of the present invention, there are provided computer-executable instructions adapted to compile at least one set of user assessment data, said user assessment data being used to assess a user's risk of injury caused by operating by a computer, said computer-executable instructions being adapted to execute the steps of;
(i) receiving computer usage data, and
(ii) receiving user feedback data, and
(iii) compiling said received user feedback data and computer usage data into a user assessment data set.

According to yet another aspect of the present invention, there are provided computer-executable instructions adapted to compile at least one set of user assessment data, said user assessment data being used to assess a user's risk of injury caused by operating by a computer, said computer-executable instructions being adapted to execute the steps of;
(i) receiving computer usage data, and
(ii) receiving user feedback data, and
(iii) receiving computer configuration data, and
(iv) compiling said received user feedback data, computer usage data and computer configuration data into a user assessment data set.

The present invention is adapted to provide a system and method for capturing data to be used to assess injury risk. The form of this data, and therefore the injuries for which risk is to be assessed may vary widely depending on the application in which the present invention is to be employed.

The present invention may facilitate the collection of a user assessment data set which is preferably supplied, made available, or transmitted to a risk assessment system.

In general, reference will be made throughout this specification to the present invention being employed to capture data to be used to assess the risk of repetitive strain injuries (RSI) occurring through the use of computer systems. RSI is a complaint which occurs frequently when a wide number and range of risk factors are present for a sufferer, with all of these risk factors contributing to the resulting injury.

However, in other embodiments data associated with different types of injuries, ailments or complaints may be captured in conjunction with the present invention.

Reference throughout this specification will, however, be made to the present invention being used to capture data employed to assess a user's risk of developing an RSI related complaint. However, as discussed above those skilled in the art should also appreciate that other types of data for different injuries and a user's risk of developing same may be captured in conjunction with the present invention if required.

The present invention may be employed to assess users, potentially with a view to identifying users with a high risk of developing an injury. Through allowing the capture of relevant data, such an assessment may identify such users for immediate treatment or consideration before their injury involved has actually developed or become acute.

The present invention relates to a system and method configured to capture injury risk assessment data. In general terms the present invention will be discussed throughout this specification as being implemented by a computer software-based tool configured to execute the methodology discussed below. Those skilled in the art should appreciate that the present invention therefore encompasses this methodology, computer-executable instructions adapted to facilitate the method involved, as well as computer hardware or equipment programmed with such instructions. A system or apparatus as discussed throughout this specification may encompass the use of a processor where this processor is programmed with appropriate computer-executable instructions.

Reference throughout this specification will also be made to a user of the present invention being a person who operates a computer system and is at risk of developing RSI. However, those skilled in the art should also appreciate that employers or others with a vested interest in ensuring the health, safety and productivity of computer users may all employ the present invention.

The present invention may preferably capture data employed to assess a user's exposure to a plurality of risk factors which are associated with the injury involved. In general terms the larger the number of risk factors for which data is captured the more accurate the risk assessment made can become. Those skilled in the art should appreciate that the risk factors considered will vary depending on the injury type involved and the data available from users from which an assessment may be made. These risk factors may be identified through research available in the field but need not necessarily be fully understood with respect to the impact they have on risk when compared with other factors.

In a further preferred embodiment, risk factors to be considered may include;
Level of computer use and breaks; Average and peak levels of computer use, number and length of breaks, level of mouse use, number of keystrokes.
Speed and intensity of work; Typing speed, work/rest ratio, precision of mouse movements, mouse clicks/movements, monotonous or repetitive work.
Existing Symptoms; Level of existing symptoms, location and duration of symptoms, current injury or history of past injury.
Posture and workstation ergonomics; Posture, positions of neck, forearms, hands and upper body, layout of desk, chair, screen, mouse and keyboard, copyholder.
Computer configuration data; Type of mouse used and duration of use, type of keyboard used and duration of use.
Workload and work environment; Quality of relationships with management and co-workers, support levels, company culture, job satisfaction, perceived workload, variability in workload, stress levels, ability to take breaks, control over type and amount of work, flexibility of work.
Individual factors; Physical fitness, muscle strength, gender, personality type, reaction to stress, coping abilities.

However, those skilled in the art should appreciate that the above list of risk factors should in no way be considered as definitive. A wide range and number of risk factors may have associated data captured in conjunction with the present invention, and the examples provided above should not be considered to be exhaustive of the capacity of the present invention.

Preferably the present invention is adapted to capture and compile a user assessment data set to be used to make an assessment with respect to a user's injury risk. This assessment data set may preferably be drawn from a variety of sources to give data as to the risk factors to which a user is exposed.

Preferably, a user assessment data set may be composed of or incorporate a plurality of user risk variables. These variables may change from user to user and be indicative of each user's exposure to a particular risk factor. Furthermore, in some instances, a single risk variable may be representative of a user's exposure to more than one risk factor or alternatively represent exposure to a single risk factor. In general terms a user risk variable may effectively provide a quantifiable measure of a user's exposure to a risk factor.

For example, in a preferred embodiment, where the risk factors of typing speed and typing period durations are to be considered, associated user risk variables may be provided directly through measuring a user's typing speed and typing period duration. Those skilled in the art should appreciate that the form of user risk variables considered will be directly dictated by both the risk factors to be considered as well as the types of user assessment data available.

In a preferred embodiment, such user assessment data may include computer usage information which is recorded or captured during the user's normal operation of a computer system. In particular, such information can include information relating to the use of a keyboard and/or mouse by a user. Such usage information may include typing and mouse movement and/or mouse button click event information. This information may also include timing information with respect to periods over which computer use occurred, as well as any breaks or pauses completed by the user during operation of a computer system.

Computer usage information can give a direct measure as to the input behaviours of a user and the intensity of these behaviours within specific time frames. This information may be readily captured using computer software processes running in the background as a user works with their computer. This type of usage information is highly valuable in the assessment of risk, in that most users have no clear idea of actually how much use they make of their computer system and the intensity or timeframes under which use is undertaken. The provision of computer usage information can provide accurate data with respect to these types of risk factors which a user can be exposed to.

In a preferred embodiment, the present invention may also be adapted to capture user feedback data. In such instances, a user assessment data set may include information drawn directly from a user through a feedback questionnaire or through an interview or meeting completed with the user. Such information may span a variety of fields and relate to areas which may not necessarily be measured or investigated through simple computer usage information.

For example, in a further preferred embodiment where the risk factors discussed above are considered, a user feedback questionnaire may be tailored to request responses from a user on all identified risk factors irrespective of whether these risk factors are encompassed by available computer usage information. Users may report on their own perception of computer usage levels as well as, for example, their own perception of their posture and workstation ergonomics, and the existing physical complaints they may have as well as the speed and intensity of work, work load and work environment, and the individual factors of risk discussed above.

In a preferred embodiment, user feedback data may include information relating to the environment in which a user has employed or is employing a computer.

For example, in embodiments where a user is employing a laptop, the data capture system provided may also request further feedback from the user with regard to where they are currently using their laptop. Furthermore, these feedback requests may be presented to users frequently (such as every time the laptop is powered up) to ensure that data is captured with respect to the changing work environment of the laptop user. In such instances the laptop user can frequently give information on the support surface used to support the computer system or components thereof, and/or the seat they are currently using, or any other relevant variables which can have an impact on risk factors associated with the injury eventually to be assessed.

This type of information is important in assessing laptop users, as generally only the laptop user will have access to all information regarding where the laptop is used at all times. In the case of businesses or other similar organisations a health and safety officer will not normally have access to or be able to assess the quality of the working environment of a laptop user outside of a static office situation.

In some embodiments, a user assessment data set may also incorporate data not sourced directly from the user for which an injury risk is to be assessed. For example, it may not be possible to collect all requested data or information that is employed to compose the full or entire user assessment data set. In some cases users may be confused by questions presented to them or may refuse to supply the information requested due to cultural or religious grounds. When one or more user responses are absent, data sourced from a population of other computer users or peers of the computer user may be employed to fill in or supply missing information. Preferably, such population-based data may be selected from the average or standard response usually given so as not to inadvertently bias or contaminate the user assessment data set to be considered.

In a further preferred embodiment, a relevant population of computer users may be selected to supply such missing information. If for example the user to be assessed works in a niche field or has a method of operating a computer system unique to a particular field, other users from this field may be selected to provide the population of computer users required.

In a preferred embodiment, missing response information may be sourced from or supplied by a remote dynamic data store. Such a data store may be configured to store user assessment data sourced from a plurality of users and hence using assessment data of an appropriate population of users.

In a preferred embodiment, the present invention may also be adapted to receive or compile computer configuration data into the user assessment data set it provides. Such computer configuration data may give information with respect to the identity of any optional or variable external input hardware or display systems which may be interfaced with a computer system.

This type of configuration data is highly important when laptop users are to be assessed as the use of external keyboards, mice and display screens all substantially reduce the laptop user's risk of injury. In a further preferred embodiment, computer configuration data may identify both the external hardware interfaced with the computer system, in addition to time information with respect to when such hardware was interfaced, when it was removed, and/or the time periods over which it was employed by a user. Furthermore, in other instances such configuration data may also provide time-based information with respect to periods when such external hardware was not interfaced with the computer system, such as for example, the time period over which a user employed a laptop's built in keyboard, screen and trackball or touchpad mouse.

As discussed above, the present invention also encompasses a system or collection of computer hardware adapted to facilitate the method of data capture discussed. Preferably, such a system may incorporate a processor which can be loaded with computer-executable instructions. This processor may form part of a computer system which is actually employed by a user and can concurrently capture computer usage information as this computer system is normally used. Such a system may also present the user involved with a feedback questionnaire to capture at least a portion of the user assessment data employed.

Preferably, such a data capture system may also include an input means configured to provide data or information to the processor discussed above. Such an input means may be formed from, for example, the standard input elements or devices used with a computer system such as a mouse, external screen or keyboard. Through the mouse and keyboard users may enter data directly into the computer system employed. Such entered data may not necessarily be compiled directly into a user assessment data set, but instead may be processed or analysed to provide computer usage data in some instances. Alternatively, the keyboard and mouse can be used in conjunction with the presentation of a questionnaire to a user to capture user feedback data.

In a further preferred embodiment, the input means employed may also consist of software algorithms or processes which detect specific computer configuration information, such as whether a separate external mouse, screen or keyboard is connected to a computer system, and in particular connected to a laptop. Such functionality may be implemented within an input system to track the varying behaviours of computer users depending on the current environment in which they are using their laptop.

In preferred embodiments, the data capture system provided may also include a local data storage means. This local data storage means can be configured or adapted to store the user assessment data set compiled in conjunction with the present invention. For example, in a further preferred embodiment, a local data storage means may be formed from a hard drive or other similar computer-readable media integrated within the computer system employed to provide the data capture system. The local hard drive of the computer system can be used to cache or buffer this information, and also in some instances store same long term if required.

In a preferred embodiment, and output means of a data capture system may include a communications interface which allows a captured user assessment data set to be transmitted to a further injury risk assessment system.

In an alternative embodiment, the data capture system discussed may be implemented in tandem with such an injury risk assessment system where this feature of the output means can be executed internally through the assignment of data access permissions to relevant computer-executable instructions. For example, in such an embodiment the data capture system and an injury risk assessment system may be implemented through computer-executable instructions to run on a single local desktop computer system. In such embodiments, a user may employ a single computer system to provide both the data capture and injury risk assessment systems where the data captured is provided to the injury risk assessment system through allowing it to access the data.

However, in alternative embodiments, the present invention may be implemented as a stand alone data capture system, and reference to the above in the main throughout this specification should in no way be seen as limiting.

In some embodiments, an output means may also include or encompass a computer monitor. A computer monitor may be used to display a compiled user assessment data set to the user involved on request if required.

In a preferred embodiment, an output means of a data capture system may be in communication with a dynamic data store. Such a data store may be configured to store a plurality of assessment data sets drawn from at least one population of computer users. The dynamic data store involved may in some instances classify users submitting assessment data sets depending on their modes of behaviour, organisation types for which the user works or any other relevant criteria to resolve individual and distinct populations of users.

In a further preferred embodiment, a dynamic data store may be provided through a database connected to or associated with a computer network. This dynamic database may be updated constantly with user assessment data from new users, or alternatively may update old user assessment data once the user involved generates new user assessment data. This database may also store old and new user assessment data to track the risk reduction progress of a user or organisation.

In some embodiments, such a dynamic data store may provide both input to the data capture system as well as receive the output of the data capture system. For example, in some instances, a remote dynamic data store can supply population-based data or information to finalise an incomplete user assessment data set substantially as described above. The dynamic data store may supply missing information selected from the average or standard response usually given by an appropriate population of users. Furthermore, in such embodiments the dynamic data store may also be engaged with the output means of the invention to allow the collection and storage of user assessment data as this data is captured.

The present invention may provide many potential advantages over prior art data capture systems.

The present invention may preferably facilitate the capture of computer usage, computer configuration and also user feedback data or information within a single user assessment data set. The breadth of data collected for such a set can be used to span a wide range and number of significant risk factors which may contribute towards a user's risk of an injury developing. The present invention may facilitate the provision of relatively accurate risk assessments for users based on such input data.

In particular, the present invention may also greatly improve the accuracy with which risk classifications may be prepared for laptop users. Through considering both the external hardware preferably interfaced with the laptop in addition to frequently prompting the laptop user to advise of their working environment, highly relevant and useful assessment data may be gathered by the present invention.

Furthermore, these compiled sets of assessment data may also be supplied to a remote dynamic database to allow for the creation of populations of assessment data.

### BRIEF DESCRIPTION OF DRAWINGS

Further aspects of the present invention will become apparent from the following description which is given by way of example only and with reference to the accompanying drawings in which:

FIG. 1 shows a block schematic diagram of components employed to provide a data capture system in accordance with one embodiment;

FIG. 2 shows a schematic diagram of components employed to provide a data capture system in accordance with a further embodiment where numerous user computer systems are provided in combination with a remote central server and data store;

FIG. 3 shows a flowchart overview of the processes executed by computer-executable instructions run on each of the user computer system machines shown with respect to FIG. 2;

FIGS. 3a-3h provide further details with respect to each of the sub-processes illustrated with respect to FIG. 3;

FIG. 4 shows a flow chart overview of the processes executed by computer-executable instructions run on the central server shown with respect to FIG. 2;

FIGS. 4a, 4b provide further details with respect to a pair of the sub-processes illustrated with respect to FIG. 4;

FIG. 5 shows a screen shot of computer usage data compiled and employed by the data capture system discussed with respect to FIG. 1;

FIGS. 6a-d show screen shots of a user feedback questionnaire tool configured to prompt and receive user feedback data to be employed by the data capture system as discussed with respect to FIG. 1; and

FIG. 7 illustrates a tabular format of compiled user assessment data provided or recorded in conjunction with a further embodiment of the present invention.

### BEST MODES FOR CARRYING OUT THE INVENTION

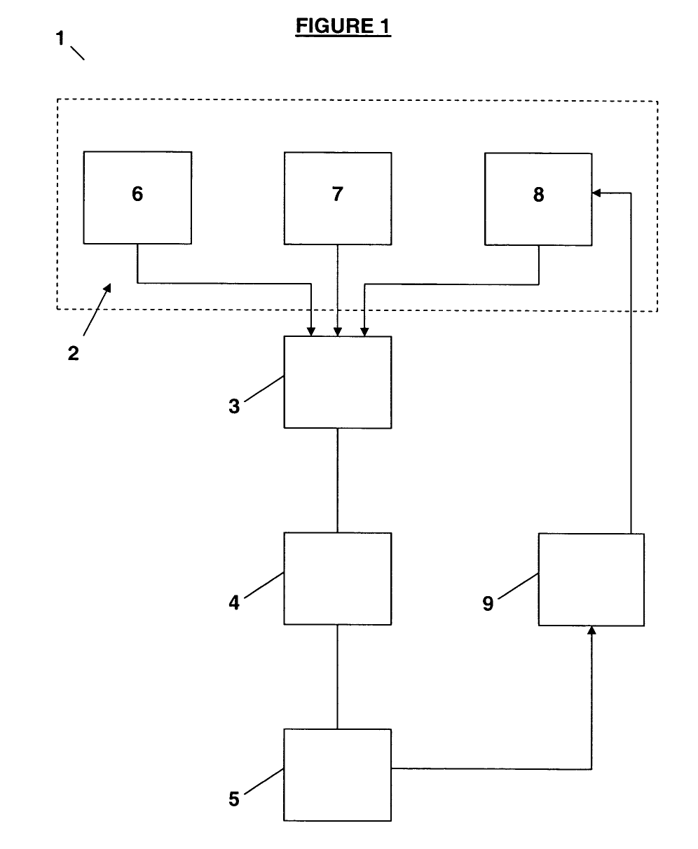

FIG. 1 shows a simplified block schematic diagram of components employed to provide a data capture system in accordance with one embodiment.

The system (1) includes an input means (2) formed from three separate modules used to receive or capture three different forms of data.

The system (1) also includes a processor (3) adapted to receive data from the input means (2) and to compile same into a user assessment data set. The processor (3) is also configured to operate a number of software processes used to facilitate the entry or reception of information by the input means (2) and its related modules.

The system (1) also includes a local data storage means, formed in this embodiment preferably by a hard drive (4) interfaced with the processor (3). This hard drive is configured to buffer or cache (and in some instances store for long periods of time) user assessment data sets captured by the system.

The system (1) also includes an output means (5) which includes (not shown) a computer display screen and a computer network communications interface (not shown). The display screen of the output means may be used to display user assessment data sets to observers of same. The communications port may in turn provide a connection to a remote dynamic database (9) used to store user assessment data sets from comparatively large populations of users.

The subsystems of the input means (2) include a computer usage data module (6), computer configuration data module (7) and a user feedback data module (8).

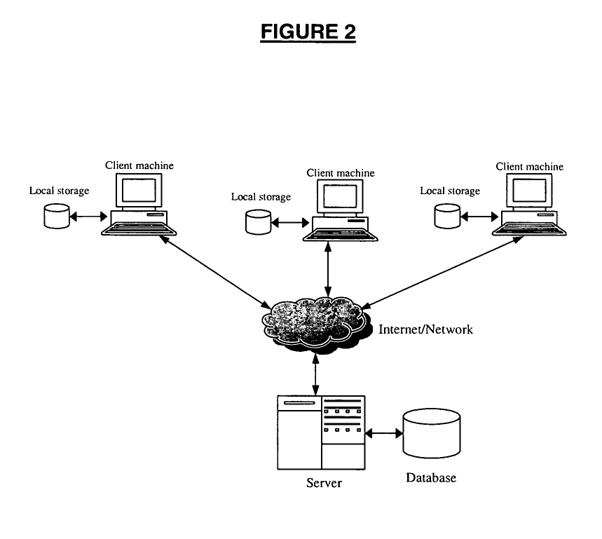

FIG. 2 shows a schematic diagram of components employed to provide a data capture system in accordance with a further embodiment where numerous user computer systems are used in combination with a remote central server and data store.

The embodiment of the invention shown is implemented in two parts, being machine-executable client code that runs on each user's client machine (each copy being identical) and machine-executable client code that runs on the server machine.

The client machines include the following components, or equivalent functionality:
1) A CPU, or central processor for executing the machine instructions.
2) An output display for displaying results and questionnaires (e.g. a VDU).
3) A local storage device for storing the machine-executable code and local copies of configuration files and user data (e.g. a hard drive or equivalent).
4) Appropriate hardware and software for communicating with the central server (e.g. an Ethernet interface).
5) Input devices for the user to input data into the client machine (e.g. keyboard/mouse).

The server machine includes the following components, or equivalent functionality:
1) A CPU, or central processor for executing the machine instructions.
2) A local storage device for storing the machine-executable code and local copies of configuration files and user data (e.g. a hard drive or equivalent).

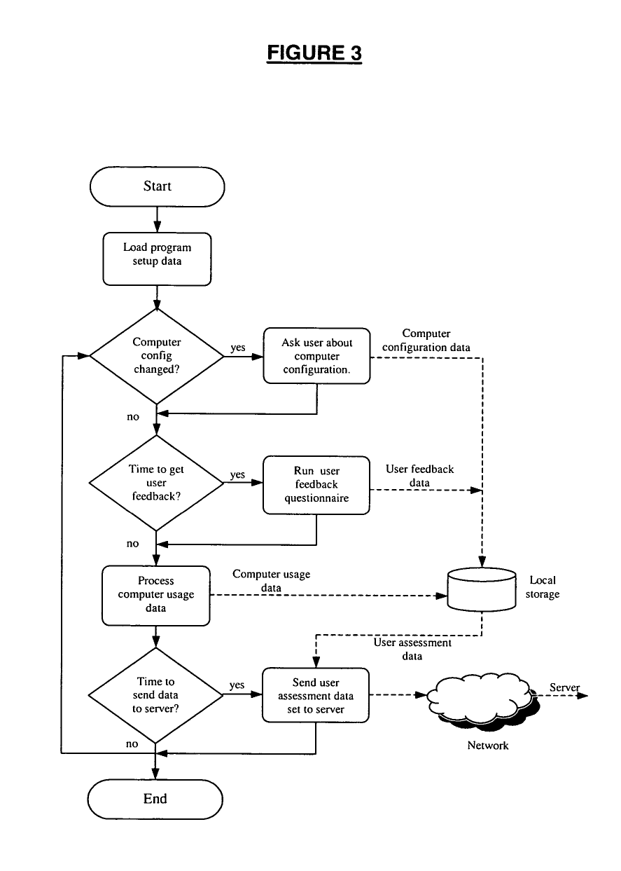

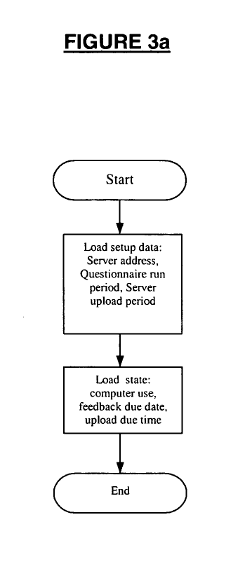

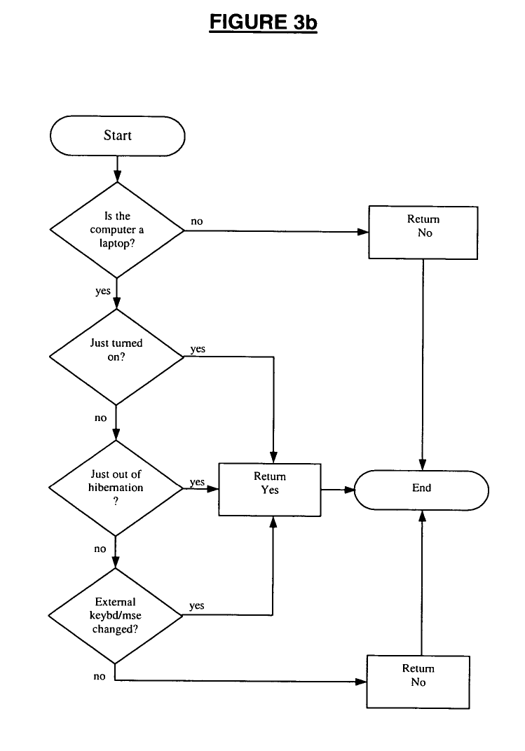

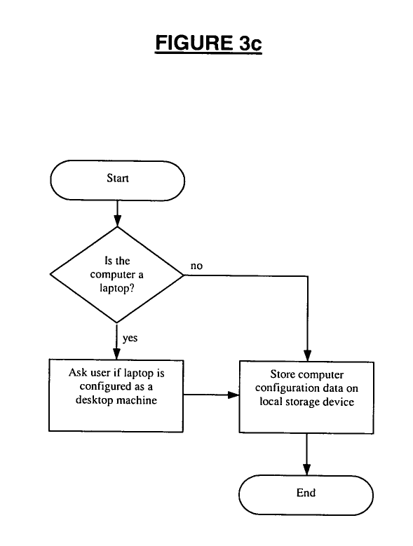

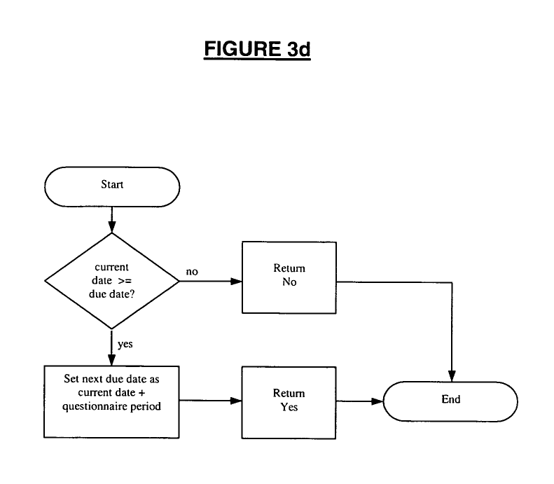

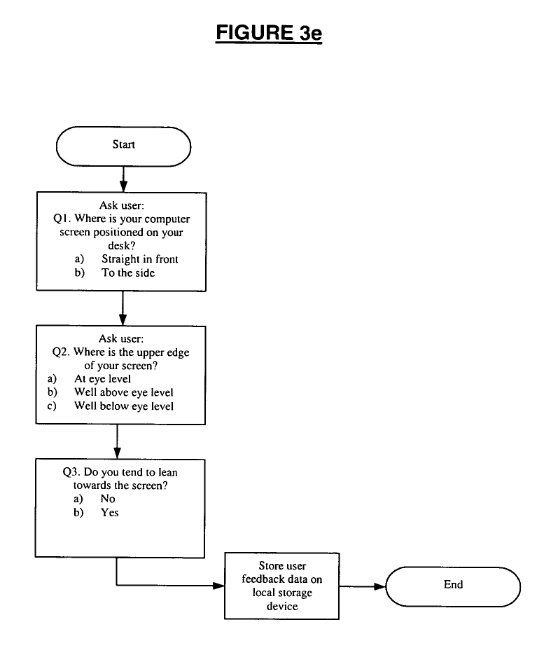

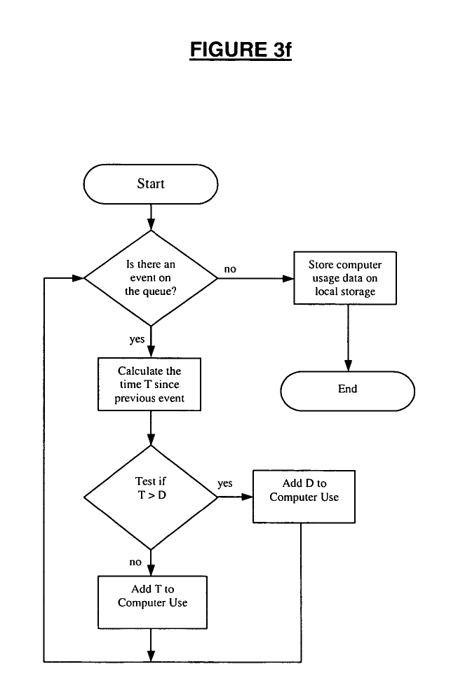

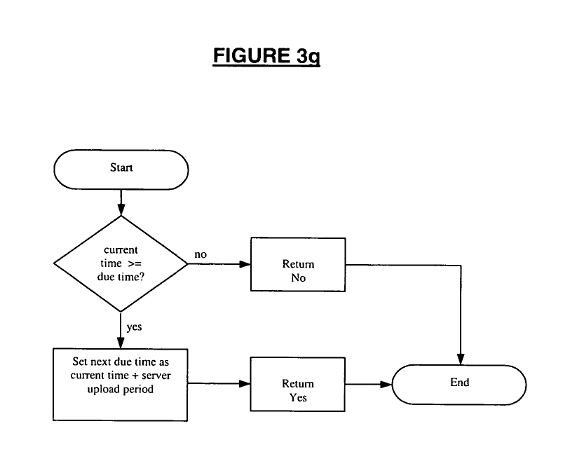

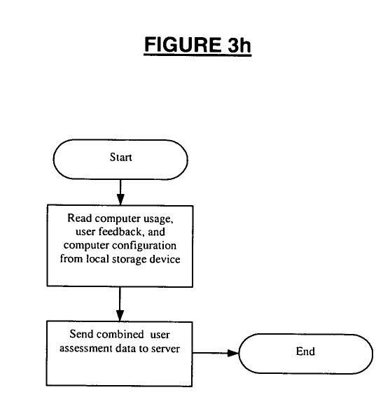

FIG. 3 shows a flowchart overview of the processes executed by computer-executable instructions run on each of the user computer system machines shown with respect to FIG. 2.

The diagram describes a continuous loop of instructions consisting of the steps of:
1) Testing if the computer configuration has changed and if it has, collecting an update from the user on the computer's configuration. The collected data is stored locally.
2) Keeping a timer that determines when to run the user feedback questionnaire. After the questionnaire is run, the user feedback data is stored locally.
3) Processing the user input (i.e. keystrokes, mouse use) and storing the computer usage data on the local storage.
4) Keeping a timer that determines when to send the user assessment data from the local storage to the server.

FIG. 3a illustrates further detail of the ‘Load program set up’ data process illustrated with respect to FIG. 3. This process initializes the program before entering the main loop of instructions. It consists of loading setup information and initializing the program.

FIG. 3b illustrates further detail of the ‘Computer Configuration Changed?’ process illustrated with respect to FIG. 3. This process determines whether or not the computer configuration has changed. It consists of a series of tests to determine if a change has occurred. For example, in one instance the client machines operating system may be required to report which external input or output devices are currently connected to the machine, and to identify such devices. Through polling the operating system for such device information, a change in computer configuration can be detected.

FIG. 3c illustrates further detail of the ‘Ask user about computer configuration’ process discussed with respect to FIG. 3.

In this embodiment a user is asked whether or not the laptop is configured in a ‘desktop’ manner (i.e. external mouse and keyboard, and laptop holder). In a more complex embodiment, the configuration questions can be expanded to include the type of keyboard, type of mouse, the positioning of the laptop, the size of the screen and so forth. The answers to the questions are stored on the local storage device for uploading to server at a later time.

FIG. 3d illustrates further detail of the ‘Time to get user feedback’ process discussed with respect to FIG. 3. This process determines when it is time to collect user feedback. Typically such data would be collected every three months, however this is configurable depending on the requirement of the invention's users.

FIG. 3e illustrates further detail of the ‘Run feedback questionnaire’ process discussed with respect to FIG. 3. This process runs the user feedback questionnaire. In this embodiment, three Posture and Workstation questions are asked. In a more complex embodiment, the invention would cover many more conditions contributing towards risk, such as existing symptoms, posture and workstation ergonomics, individual factors, workload, work environment and so forth. The results are stored on the local storage device for upload to the server at a later time.

FIG. 3f illustrates further detail of the ‘Process computer usage data’ process discussed with respect to FIG. 3. Processing of the computer use data consists of analyzing the user's keystrokes and mouse use to determine the computer use for the day. In this embodiment of the invention, only the computer use for the day is calculated for the purpose of risk assessment. In more complex embodiments other statistics can be incorporated such as number of keystrokes, number of mouse clicks, time spent using the keyboard, time spent using the mouse, number of breaks taken and so forth. The resulting data is stored on the local storage device for upload to the server at a later time.

FIG. 3g illustrates further detail of the ‘Time to send data to server?’ process discussed with respect to FIG. 3. This process determines when to send the data to the server. This is configurable but would typically be once a day.

FIG. 3h again illustrates further detail of the ‘Send user assessment data set to server’ process discussed with respect to FIG. 3. This process sends the combined computer use, user feedback, and computer configuration data to the server.

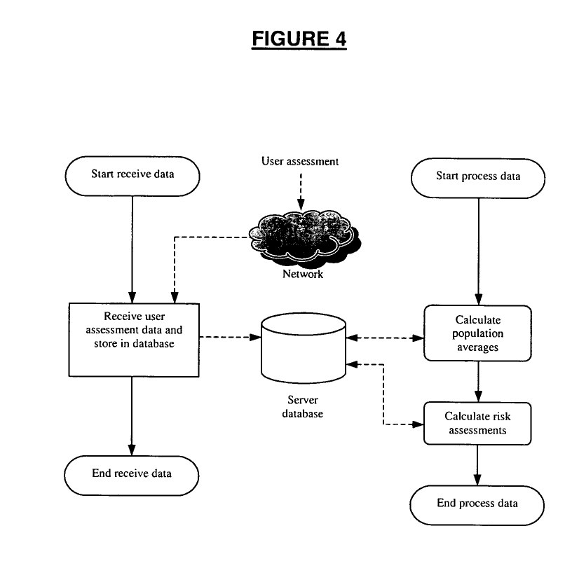

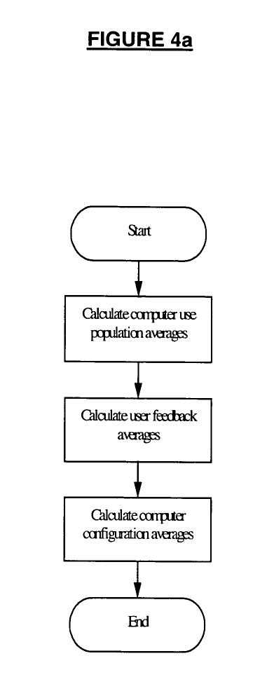

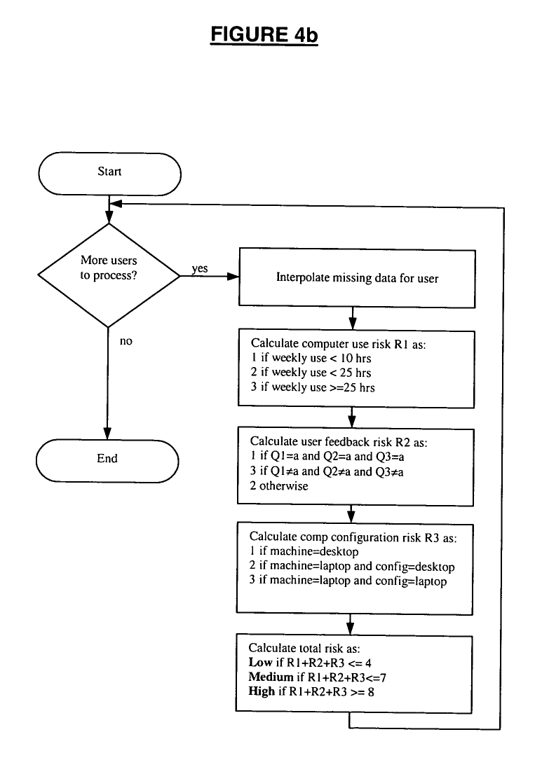

FIG. 4 shows a flow chart overview of the processes executed by computer-executable instructions run on the central server shown with respect to FIG. 2.

The purpose of the server is to process the user assessment data from all the users into a combined data set. This allows the server to generate the following key data:
1) Population averages and distributions of the user assessment data.
2) Risk assessments for each user.

FIGS. 4a and 4b provide further details with respect to a pair of the sub-processes illustrated with respect to FIG. 4.

FIG. 4a illustrates further details of the ‘Calculate population averages’ process shown with respect to FIG. 4. This process creates population averages for each of the pieces of data collected as part of the user assessment, comprising:
1) Computer use data.
2) User feedback data.
3) Computer configuration data.

FIG. 4b illustrates further details of the ‘Calculate risk assessments’ process shown with respect to FIG. 4. This process consists of calculating the risk assessment for each user in the server database. If there is any data missing for a particular user, the population average is substituted. This embodiment illustrates a simple risk assessment and clearly a more complex embodiment could use more sophisticated risk algorithms.

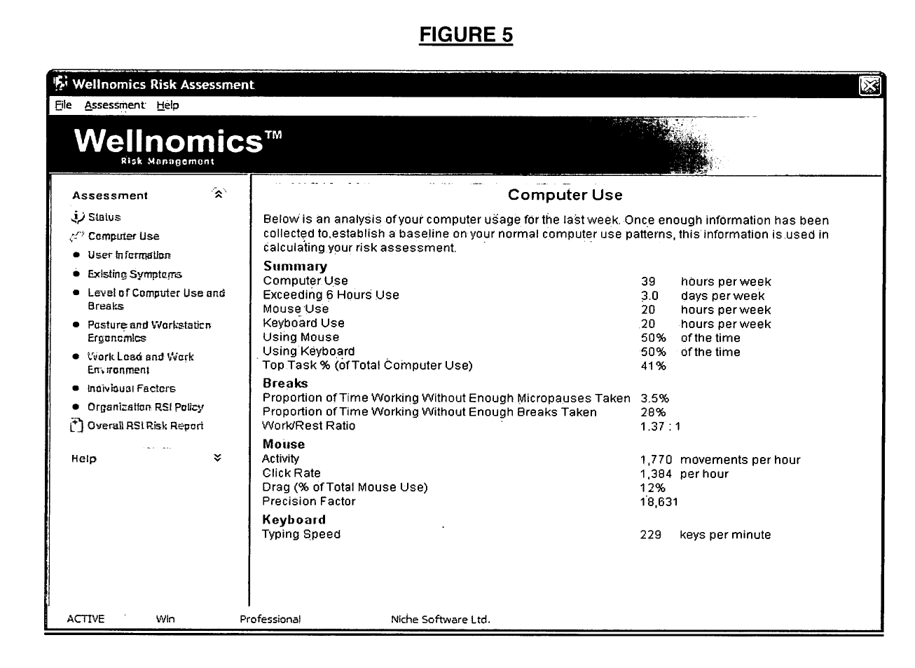

FIG. 5 shows a screen shot of the types of information incorporated into usage data, generally derived from a user's input behaviour with respect to their mouse and keyboard. This usage information may also include timing data relating to the speed of data entry as well as the breaks or pauses taken by the user during a usage period.

The invention is adapted to capture information with respect to additional computer hardware interfaced with a computer system employed by a user. In particular, the invention may capture data associated with the use of external mice, keyboards and screens with laptops.

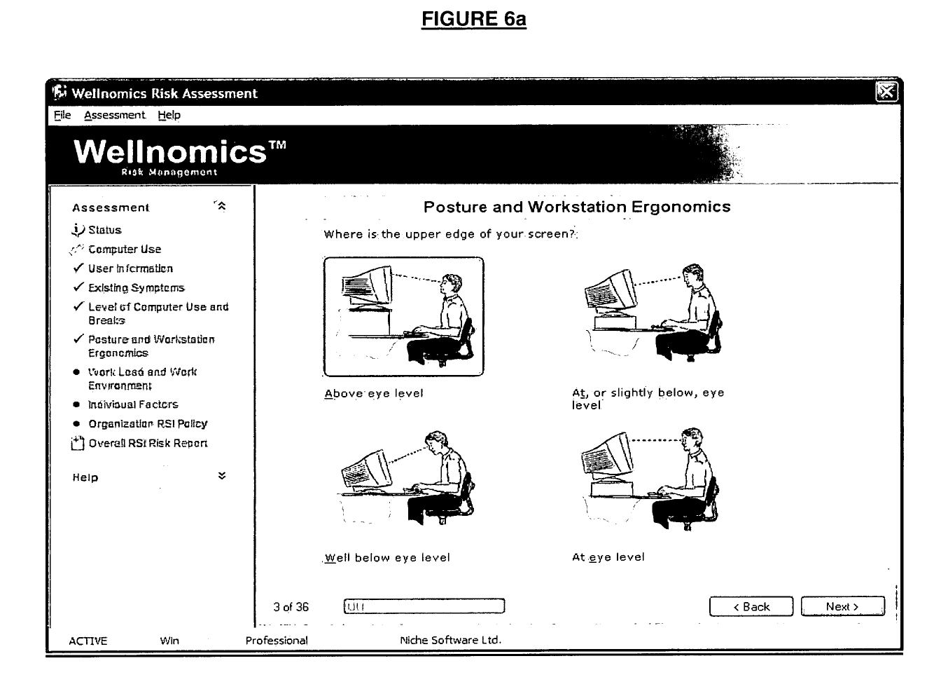

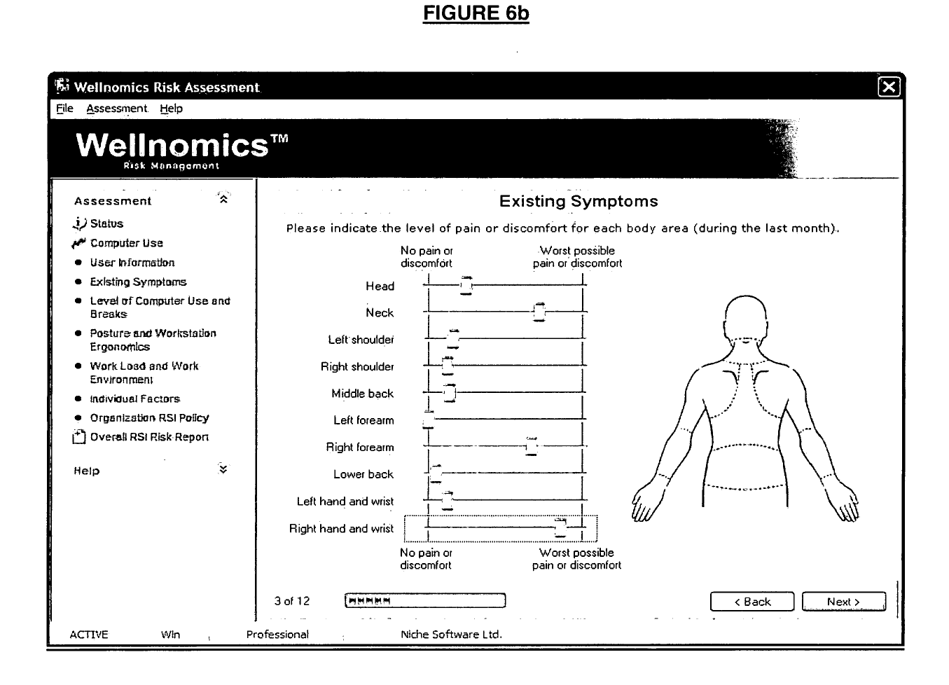

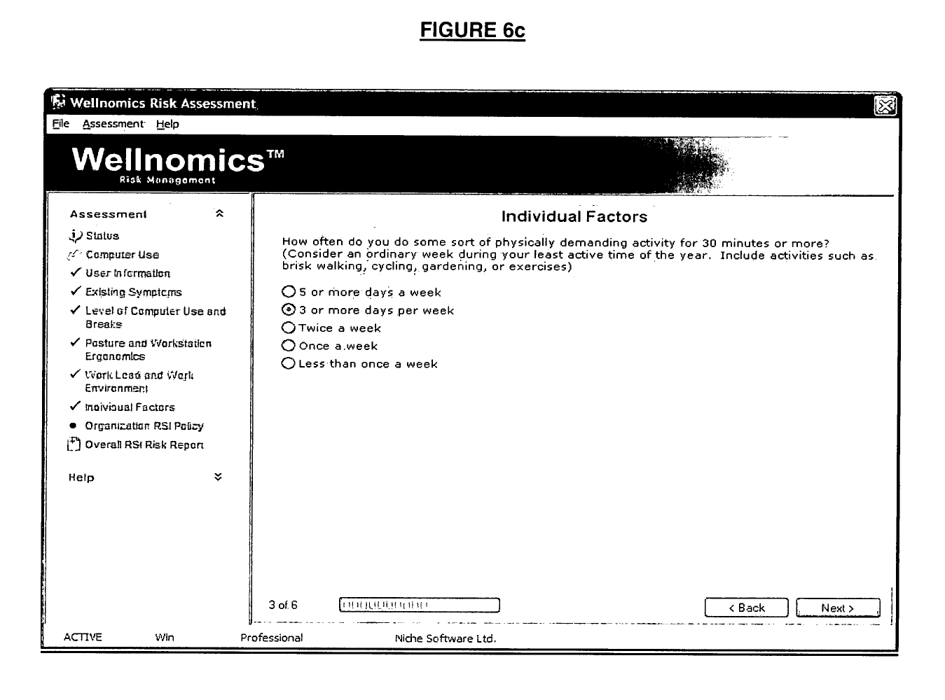

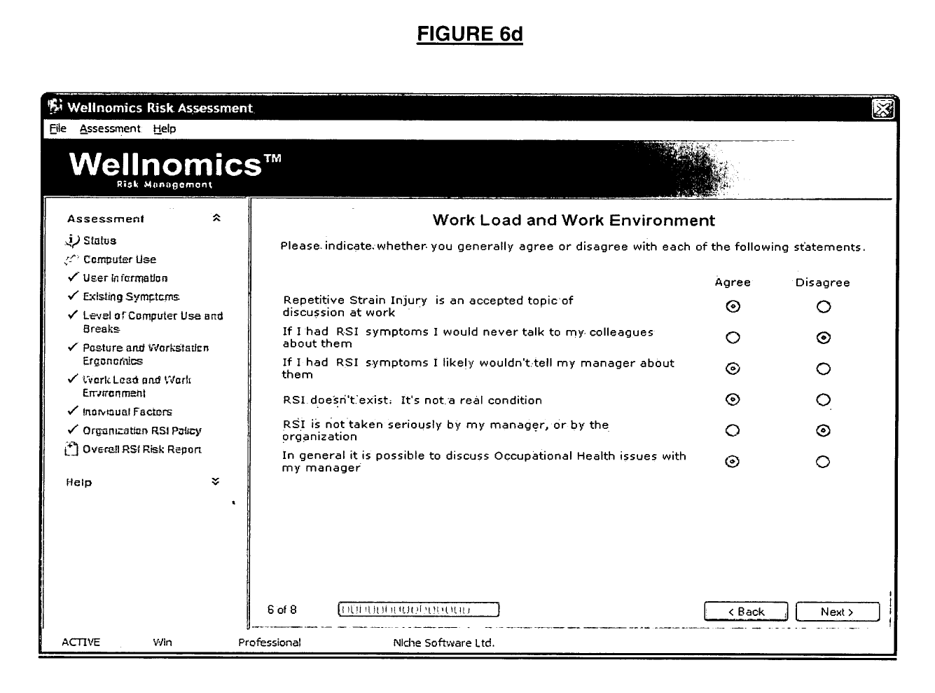

The present invention is also configured to present a series of questionnaire requests to a user, as illustrated by way of example with respect to FIGS. 6a through 6d. These questionnaire requests can gather feedback data from users which is only available through a direct request made to the user.

This system allows for the receipt, collation, and preferably the storage of a wide ranging user assessment data set. This data set may preferably span the majority if not all of risk factors present within or contributing to the development of the injury under assessment.

Furthermore, in the case of mobile computer users such as laptop users, usage data in combination with the user feedback and computer configuration data all allow for the working environment of the laptop user to be tracked and taken into account when injury risk is to be assessed.

FIG. 4 illustrates a tabular format of compiled user assessment data provided or recorded in conjunction with a further embodiment of the present invention.

In the embodiment shown, data is collected on a daily basis with the exception of questionnaire data which provides the user feedback data required. In the instance of questionnaire data, daily data is not automatically collected, resulting in the void or blank entries shown.

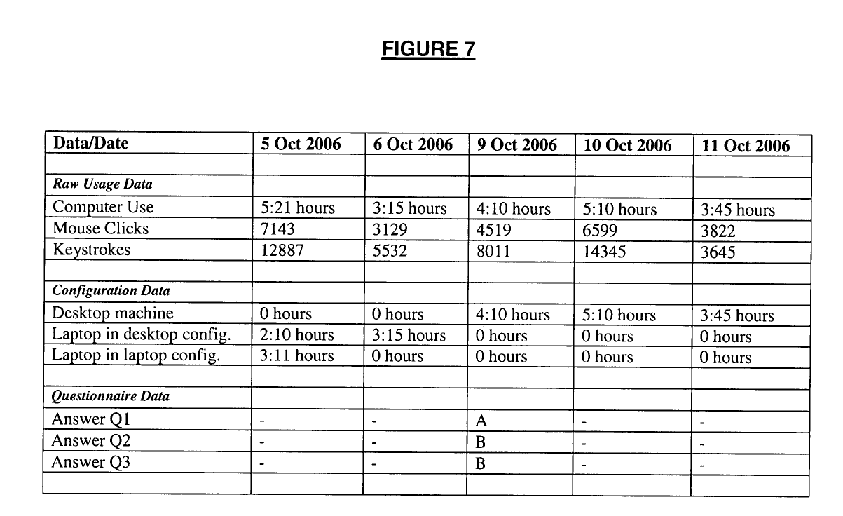

As can be seen from FIG. 7, a user assessment data set can be compiled in terms of specific computer usage parameters, computer configuration timing indicators and specific questionnaire answers provided as user feedback. Furthermore, the present invention may also act to fill in or replace missing questionnaire data. For example, if questionnaire data is not provided for the 11^{th} October date, the same user responses provided on 9^{th} October may be used.

Aspects of the present invention have been described by way of example only, and it should be appreciated that modifications and additions may be made thereto without departing from the scope thereof as defined in the appended claims.

What is claimed:

1. Computer-executable instructions adapted to compile at least one set of user assessment data, said user assessment data being used to assess a user's risk of injury caused by operating by a computer, said computer-executable instructions being adapted to execute the steps of;
(i) receiving computer usage data,
(ii) receiving user feedback data, and
(iii) compiling said received user feedback data and computer usage data into a user assessment data set.

2. Computer-executable instructions as claimed in claim 1 wherein said instructions execute the further subsequent step of:
iv) supplying the compiled user assessment data set to an injury risk assessment system.

3. Computer-executable instructions as claimed in claim 1 wherein the user assessment data set is used to assess the user's risk of repetitive strain injury occurring through use of a computer system.

4. Computer-executable instructions as claimed in claim 2 wherein the user assessment data set is transmitted to a remote injury risk assessment system using a communications interface.

5. Computer-executable instructions as claimed in claim 2 wherein the user assessment data set is supplied to an injury risk assessment system by providing data access permissions to the injury risk assessment system.

6. Computer-executable instructions as claimed in claim 1 wherein computer usage data includes information relating to the use of a keyboard and/or mouse by a user.

7. Computer-executable instructions as claimed in claim 6 wherein computer usage data includes timing information with respect to when a keyboard and/or mouse is operated.

8. Computer-executable instructions as claimed in claim 1 wherein user feedback data is compiled using a questionnaire presented to a user.

9. Computer-executable instructions as claimed in claim 1 wherein user feedback data is compiled through interview questions posed to a user.

10. Computer-executable instructions as claimed in claim 1 wherein user feedback data includes information relating to the environment in which a user has employed a computer.

11. Computer-executable instructions as claimed in claim 1 wherein information relating to the environment of computer use includes details of a support surface used to support the computer system or components thereof.

12. Computer-executable instructions as claimed in claim 1 wherein feedback data relating to the environment in which a computer is used includes information relating to a seat employed by a user.

13. Computer-executable instructions as claimed in claim 1 wherein user feedback data which has one or more user responses absent is completed using data sourced from a population of computer users.

14. Computer-executable instructions as claimed in claim 13 wherein the data sourced from a population of computer users is provided by the average response given by said population of computer users.

15. Computer-executable instructions as claimed in claim 14 wherein a remote dynamic data store is used to supply data sourced from a population of computer users.

16. Computer-executable instructions as claimed in claim 1 wherein computer configuration data is received and compiled into the user assessment data set.

17. Computer-executable instructions as claimed in claim 16 wherein said computer configuration data identifies external hardware devices interfaced with a computer system.

18. Computer-executable instructions as claimed in claim 17 wherein computer configuration data includes timing information with respect to when external hardware is interfaced with said computer system.

19. Computer-executable instructions as claimed in claim 17 wherein computer configuration data includes timing information with respect to when external hardware is removed from said computer system.

20. Computer-executable instructions as claimed in claim 1 wherein the compiled user assessment data set is transmitted to a dynamic data store configured to store a plurality of sets of user assessment data sourced from a plurality of users, said dynamic data store being configured to update stored user assessment data sets when a current user assessment data set is received for a user.

21. Computer-executable instructions as claimed in claim 20 wherein said dynamic data store is provided through a database connected to a computer network.

22. Computer-executable instructions adapted to compile at least one set of user assessment data, said user assessment data being used to assess a user's risk of injury caused by operating by a computer, said computer-executable instructions being adapted to execute the steps of;
(i) receiving computer usage data,
(ii) receiving user feedback data,
(iii) receiving computer configuration data, and
(iv) compiling said received user feedback data, computer usage data and computer configuration data into a user assessment data set.

23. A method of data capture adapted to compile at least one set of user assessment data, said user assessment data being used to assess a user's risk of injury caused by operating by a computer, said method being characterised by the steps of;
(i) receiving computer usage data,
(ii) receiving user feedback data,
(iii) receiving computer configuration data, and
(iv) compiling said received user feedback data, computer usage data and computer configuration data into a user assessment data set.

24. A method of data capture adapted to compile at least one set of user assessment data, said user assessment data being used to assess a user's risk of injury caused by operating a computer, said method being characterised by the steps of;
(i) receiving computer usage data,
(ii) receiving user feedback data, and
(iii) compiling said received user feedback data and computer usage data into a user assessment data set.

25. A method of data capture as claimed in claim 24 wherein said method includes the further subsequent step of:
iv) supplying the compiled user assessment data set to an injury risk assessment system.

26. A data capture system adapted to compile at least one set of user assessment data, said user assessment data being used to assess a user's risk of injury caused by operating a computer, said system including:
an input means adapted to receive computer usage data and user feedback data,
a local data storage means adapted to compile and store computer usage data and user feedback data into a user assessment data set, and
an output means adapted to transmit at least a portion of a stored user assessment data set.
